(19) United States
(12) Patent Application Publication
(10) Pub. No.: US 2006/0146650 A1
(43) Pub. Date: Jul. 6, 2006

(54) Telephone-watch with improved acoustics

(75) Inventor: Rudolf Dinger, Saint-Aubin (CH)

Correspondence Address: GRIFFIN & SZIPL, PC, SUITE PH-1, 2300 NINTH STREET, SOUTH, ARLINGTON, VA, 22204, US

(73) Assignee: Asulab S.A., Marin (CH)

(21) Appl. No.: 10/541,695

(22) PCT Filed: Dec. 16, 2003
(86) PCT No.: PCT/EP03/51029

§ 371 Date: Jul. 8, 2005

(30) Foreign Application Priority Data
Jan. 8, 2003 (EP) 03075099.6
Feb. 14, 2003 (EP) 03075444.4

(51) Int. Cl. G04B 47/02

(52) U.S. Cl. 368/13

(57) ABSTRACT

The present invention concerns a telephone-watch including at least one control member and a case in which there is mounted an electroacoustic transmitter transducer (103) in communication with an acoustic output cavity arranged in the case and in direct communication with the exterior via at least one output channel. The watch is characterized in that the output channel opens out on the same side of the case as the control member with respect to a 6-12 o'clock axis of the watch.

The present invention concerns a telephone-watch for both displaying the time and being used in a mobile communication system, comprising at least one control member and a case, in which there is mounted an electroacoustic transmitter transducer in communication with an acoustic output cavity arranged in the case and in direct communication with the exterior via at least one output channel.

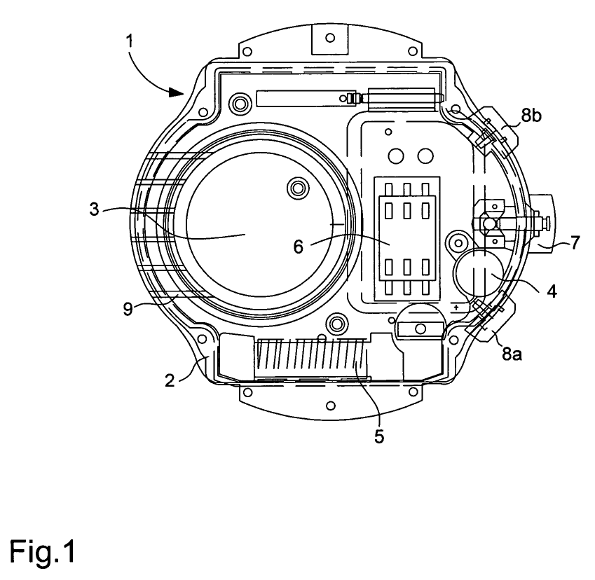

Such a telephone-watch is known from the prior art, particularly from EP Patent No. 1 126 623 filed in the name of the present Applicant. As is visible in FIG. 1, which shows a plan view of the back cover part of the watchcase, this telephone-watch comprises a case 1 formed of a crystal, a middle part and a back cover 2. Only the back cover is shown in this Figure.

In its back cover 2, the telephone-watch comprises a loudspeaker 3 and a microphone 4. In addition to other elements the function of which will not be detailed here, such as a charge coil 5 supplying recharge energy to an accumulator that is not shown, a housing 6 for a SIM card, etc. . . .

Loudspeaker 3 and microphone 4 are separated in a water-resistant manner from the exterior. Construction examples of such water-resistant structures are given in EP Patent No. 0 899 634 for the microphone and EP Patent No. 0 899 635 for the loudspeaker, both filed in the name of the Applicant and incorporated herein by reference.

The watch also comprises at least one control member, as for example a crown arranged at 3 o'clock and two push-buttons 8a and 8b arranged respectively at 2 o'clock and 4 o'clock.

For reasons of compactness linked to the size occupied by loudspeaker 3 inside case 1, output channels 9 have been arranged on the opposite side of case 1 to that of crown 7 in relation to the 6-12 o'clock axis of the watch, these channels opening out on one side onto the exterior and on the other side into the loudspeaker output acoustic cavity, this cavity being superposed onto the latter in the example shown.

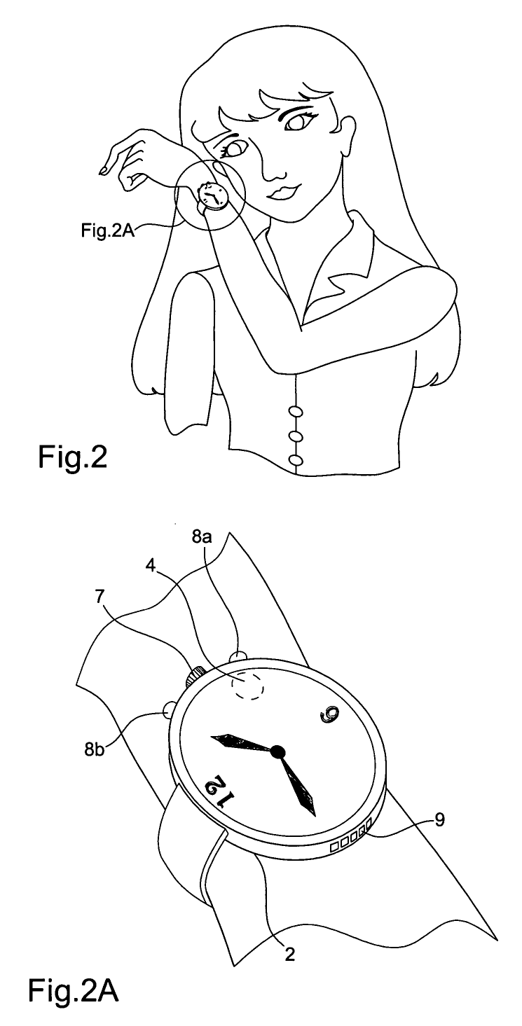

This type of construction has however a major drawback during practical use of the watch as a telephone in a noisy environment, like for example, outside in a built-up area or inside in places such as a station, a bar or shopping centre. In fact, in such difficult acoustic conditions, the user wearing his watch on his wrist will move the watch towards his ear. As is visible in FIGS. 2 and 2A, the watch is then oriented such that the loudspeaker output channels 9 are oriented towards the user's mouth and the microphone output 10 is oriented towards the user's ear. The acoustics are therefore unfavourable and telephone communication remains difficult.

One solution which would consist in the user wearing his watch on the other wrist, during telephone conversations, has not only a considerable inconvenience for the user, but also makes the use of control members 8a and 8b and more particularly crown 7 more difficult.

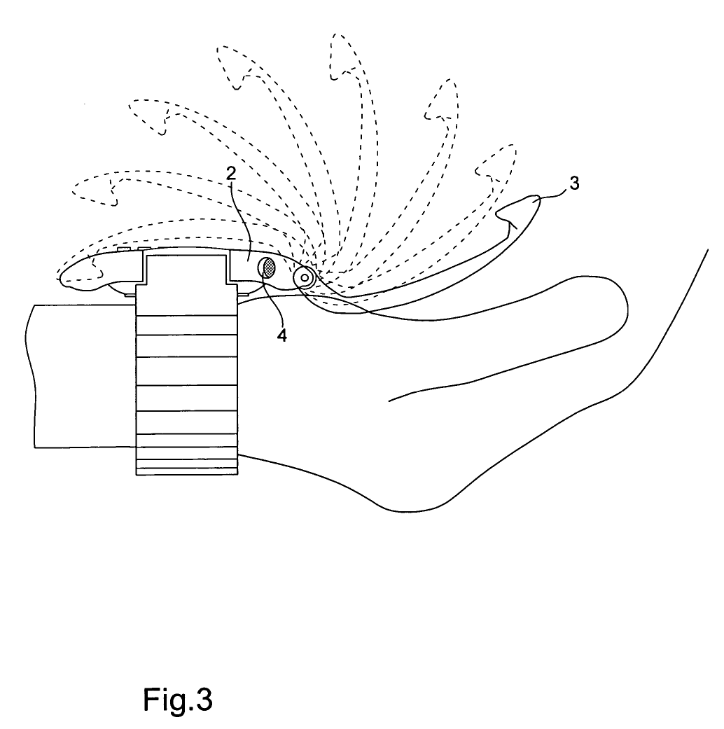

Certain already existing structures of the prior art propose to resolve this problem. FIG. 3 shows the construction proposed in DE Patent No. 100 32 697. The watch is provided with an unfolding loudspeaker 3 enabling the latter to be placed opposite the user's ear during a telephone conversation. However, this solution has numerous drawbacks. First, such a construction causes electrical connection complications between the loudspeaker and the printed circuit placed in the watchcase. Secondly, with this construction, the watch is no longer able to guarantee the minimum water-resistance conditions required, typically equivalent to a pressure of 3 bars. Thirdly, the overall aesthetic appearance of the watch is totally altered and consequently no longer has the desired advantage of compactness for an object of this type worn on the wrist, particularly when it is used as a telephone.

Numerous other Patent documents of the prior art, particularly JP 2001-028620, WO 98/27 702, WO 98/05 148, EP 0 871 236 all propose constructions having similar drawbacks to those of DE 100 32 697.

In order to overcome the drawbacks of the prior art, the idea according to the invention, is to make a telephone-watch whose electroacoustic transducers, microphone and loudspeaker, are placed in a single watchcase while providing good acoustics when the watch is used as a telephone.

The invention therefore concerns a telephone-watch as defined in the preamble and characterized in that the output channel opens out on the same side of the case as said control member in relation to a 6-12 o'clock axis of the watch.

Advantageously, the electroacoustic transducers are mounted in the case in a water-resistant manner.

Other features and advantages of the invention will appear during the following description, given solely by way of example and made with reference to the annexed drawings, in which:

FIG. 1, already described, shows a telephone-watch according to the prior art;

FIGS. 2 and 2A, already described, show the use of the telephone-watch of FIG. 1, during a telephone conversation;

FIG. 3, already described, shows a mobile telephone able to be worn on the wrist according to the prior art;

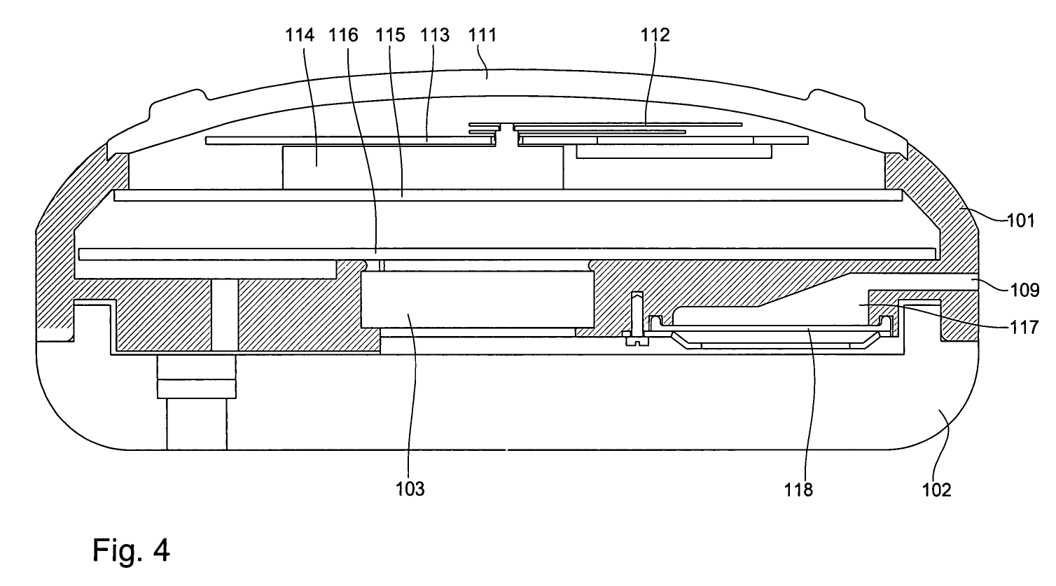

FIG. 4 shows a cross-section of a telephone-watch at its electroacoustic transmitter transducer according to a preferred embodiment of the invention;

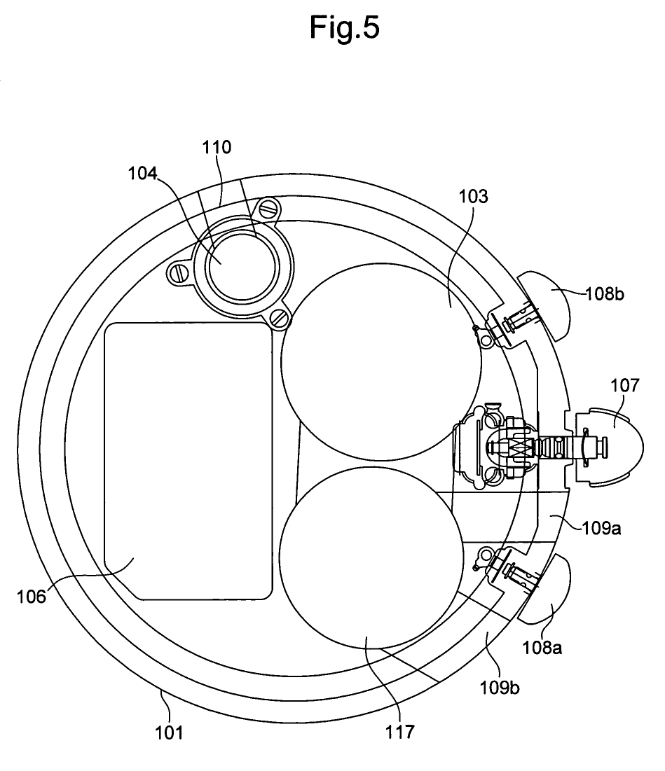

FIG. 5 shows a plan view of the watchcase according to the embodiment of FIG. 4; and

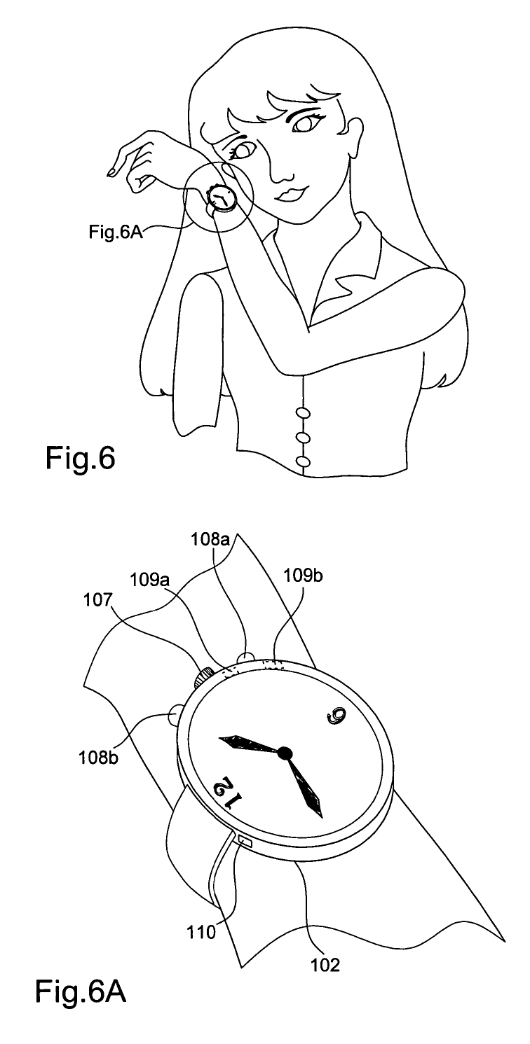

FIGS. 6 and 6A show a use of the telephone-watch during a telephone conversation according to the embodiment of FIGS. 4 and 5.

According to a preferred embodiment of the invention illustrated in FIG. 4 which shows a cross-section of the electroacoustic transmitter transducer of a telephone watch, preferably water-resistant, whose water-resistance is guaranteed to at least a depth of 30 meters, which is a value often provided in practice.

This watch comprises a case 101, a crystal 111, hands 112, a dial 113, a miniature motor 114, a watch printed circuit board or PCB 115. All of these elements, and those that are sketched or not even visible in this Figure, like the quartz, the gear train, the integrated circuit, etc. are conventional and will not therefore be described here. It will be noted that it is possible to provide a second printed circuit 116 for the telephone function of the watch.

In the case shown, case 101 comprises a back cover 102 secured in a water-resistant manner to the case by any means, for example bonding, screwing or snap fitting. It will be noted that back cover 102 and case 101 could be formed by a single moulded part. Case 101 has an acoustic output cavity 117 that is in direct communication with the exterior through at least one output channel 109, which opens into it laterally.

According to the preferred embodiment shown, a membrane 118 makes the inside of the watch water-resistant as regards the exterior. Membrane 118 is made of a deformable material that is water-resistant and gas resistant, for example silicon. Pressure compensation means that are not shown are provided.

An electroacoustic transmitter transducer, such as for example a loudspeaker 103 is fixedly mounted in a housing of the case provided for this purpose and connected via a simple electrical contact to printed circuit 116. Transducer 103 is in communication with the acoustic cavity 117 in order to be able to transmit electroacoustic waves to the exterior via cavity 117 then output channels 109. For this purpose, transducer 103 and acoustic cavity 117 can be arranged in a collateral manner as is shown. However, other arrangements in which transducer 103 and/or cavity 117 are inclined or even superposed can be envisaged. It is also possible to use a similar loudspeaker to that defined in EP Patent No. 0 899 635, the detail of which is given in relation to FIG. 1 of that document and the corresponding passage of the description of which is incorporated herein by reference.

FIG. 5 is a plan view of the watchcase according to the embodiment of FIG. 4 particularly displaying the location of the electroacoustic transducers in relation to the control members and the acoustic cavity, which is offset according to this embodiment. This Figure shows case 101, control members, like for example two push-buttons 108a and 108b arranged on either side of a time-setting member 107, a housing 106 for receiving a SIM card, receiver electroacoustic transducer 104 and electroacoustic transmitter transducer 103.

Advantageously, as is shown, output cavity 117 of electroacoustic transmitter transducer 103 is placed in direct communication with the exterior through two output channels 109a and 109b which open out laterally on either side of one of the control members. It will be noted that these different channels have different output orientations which has the effect of improving the transmission of acoustic signals towards the exterior.

It will also be noted that input channel 110 of microphone 104 opens out on the opposite side of the case to the control members with respect to the 6-12 o'clock axis and preferably in a zone far away from where loudspeaker output channels 109a and 109b open out, input channel 110 opening out for example at 11 o'clock, which has the effect of reducing interference between the loudspeaker and the microphone.

FIGS. 6 and 6A show the telephone-watch being used during a telephone conversation according to the embodiment of FIGS. 4 and 5.

In the example shown here, unlike in FIG. 2, the output channels respectively of the loudspeaker 109a, 109b and microphone 110, are oriented respectively on the side of the user's ear and mouth, which provides better acoustics during telephone conversations, particularly in a noisy environment.

It will be noted that according to an embodiment that is not illustrated, it is preferable, in order to improve the acoustics still further, to wear the watch on the inside of the wrist such that the hand placed by the user's ear acts as a resonating chamber for the loudspeaker.

1-6. (canceled)

7. A telephone-watch comprising at least one control member and a case in which there is mounted an electroacoustic transmitter transducer in communication with an acoustic output cavity arranged in said case and in direct communication with the exterior via at least one output channel, wherein said telephone-watch includes two output channels opening out on either side of one of said control members and on the same side of the case with respect to the 6-12 o'clock axis.

8. The telephone-watch according to claim 7, wherein it includes means for guaranteeing water-resistance between said electroacoustic transmitter transducer and said acoustic output cavity.

9. The telephone-watch according to claim 7, wherein said output channels are oriented along different directions.

10. The telephone-watch according to claim 7, wherein it further includes an electroacoustic receiver transducer mounted in said case and in communication with an acoustic input cavity, the latter being arranged in said case and in communication with the exterior via at least one input channel opening out on the opposite side of said case to said control member with respect to the 6-12 o'clock axis.

11. The telephone-watch according to claim 10, wherein it includes means for guaranteeing water-resistance between said electroacoustic receiver transducer and said acoustic input cavity.

12. Use during a telephone conversation of the telephone-watch according to claim 10 wherein the output channels of the electroacoustic transmitter transducer, respectively the electroacoustic receiver transducer, are oriented on the ear's side respectively mouth side of the user and wherein the watch can be worn on the inside of the wrist so that the user's hand placed at its ear acts as a resonating chamber for the electroacoustic transmitter transducer.
